(19) United States
(12) Patent Application Publication
(10) Pub. No.: US 2002/0107459 A1
(43) Pub. Date: Aug. 8, 2002

(54) Massage device having eccentric vibrating mechanism

(76) Inventor: Horng Jiun Chang, Chang Hua Hsien (TW)

Correspondence Address: CHARLES E. BAXLEY, 5th Floor, 59 John Street, New York, NY, 10038, US

(21) Appl. No.: 09/776,116

(22) Filed: Feb. 5, 2001

(51) Int. Cl. A61H 7/00; A61H 19/00

(52) U.S. Cl. 601/97; 601/101

(57) ABSTRACT

A massage device includes a housing, a follower received in the housing and having a stem extended outward of the housing, and one or more massage members selectively and changeably secured to the stem for massaging the users. A shaft is rotatably received in the follower, and a motor has a spindle secured to the shaft at an off-center bore for moving and vibrating the follower in a reciprocating action. One or more infrared generating devices may further be attached to the housing for facilitating the blood circulation of the users.

### BACKGROUND OF THE INVENTION

1. Field of the Invention

The present invention relates to a massage device, and more particularly to a massage device having an eccentric vibrating mechanism.

2. Description of the Prior Art

Various kinds of typical hand held massage devices have been widely developed and used today, and comprise various kinds vibrating mechanisms provided thereon. The typical massage devices have no eccentric vibrating mechanism for vibrating the massage device, and have no other massage members that may be changed with each other.

The present invention has arisen to mitigate and/or obviate the afore-described disadvantages of the conventional massage devices.

### SUMMARY OF THE INVENTION

The primary objective of the present invention is to provide a massage device including an eccentric vibrating mechanism for vibrating the massage member of the massage device.

The other objective of the present invention is to provide a massage device including a number of massage members that may be changed with each other.

In accordance with one aspect of the invention, there is provided a massage device comprising a housing, a follower received in the housing and including a stem extended outward of the housing, a massage member secured to the stem for engaging with and for massaging users, and means for vibrating the follower to move the massage member to massage the users. The follower may be moved in a cam way or in a reciprocating action in order to cause the massage member to massage the users.

The vibrating means includes a shaft rotatably received in the follower and having an off-center bore formed therein, and means for rotating the shaft to vibrate the follower or to move the follower in the reciprocating action.

The rotating means includes a motor having a spindle engaged in the off-center bore of the shaft for rotating the shaft relative to the follower in an eccentric way. One or more pads are engaged between the motor and the housing for absorbing a vibration generated by the motor.

A protective covering is further provided and engaged on the stem and engaged with the housing for shielding the stem. The covering is preferably a bellows type covering.

The housing includes a handle, and an electric facility received in the handle of the housing. One or more infrared generating devices may further be provided and attached to the housing for facilitating the blood circulation of the users.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a massage device in accordance with the present invention;

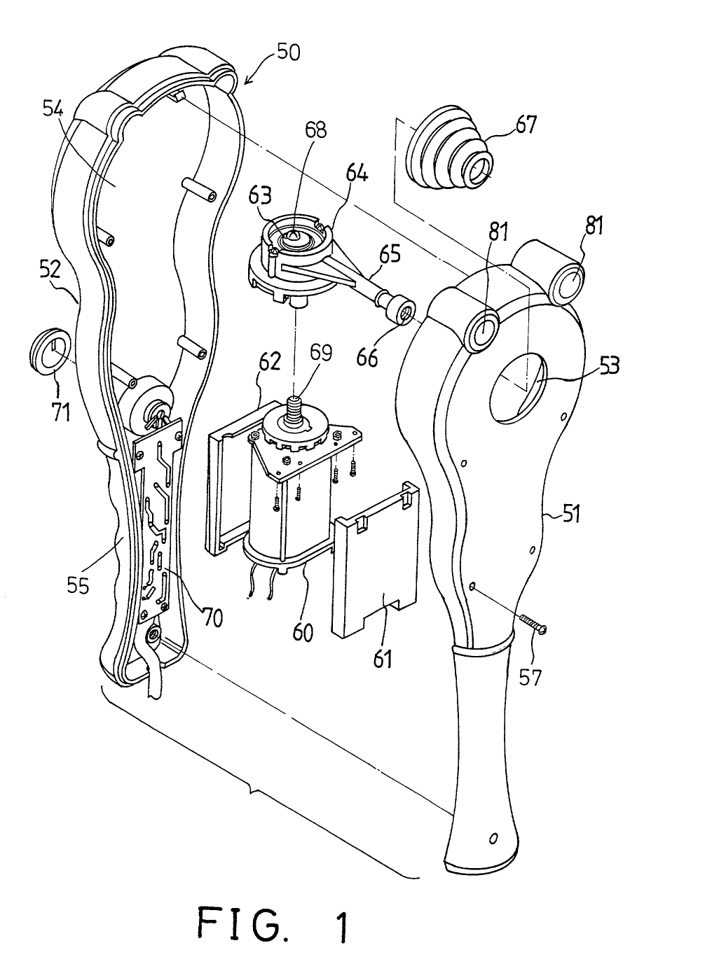

FIG. 2 is a perspective view of the massage device; and

FIG. 3 is a partial exploded view illustrating the changeable massage members for the massage device.

### DETAILED DESCRIPTION OF THE PREFERRED EMBODIMENT

Referring to the drawings, a massage device in accordance with the present invention comprises a housing 50 formed by two casings 51, 52 that may be secured together with fasteners 57 or the like. The housing 50 includes a chamber 54 formed therein, and includes a handle 55 formed or provided on one end thereof. The casing 51 includes an orifice 53 formed therein and communicating with the chamber 54 of the housing 50. A motor 60 is received in the chamber 54 of the housing 50, and one or more resilient or soft pads 61, 62 are engaged between the motor 60 and the housing 50 for absorbing the vibrations or shocks generated by the motor 60. A circuit board or an electric facility 70 is received in the housing 50, such as received in the handle 55 and coupled to the motor 60 for controlling or actuating the motor 60. A button or a knob 71 may be attached to the casing 52 and coupled to the motor 60 for controlling or actuating the motor 60.

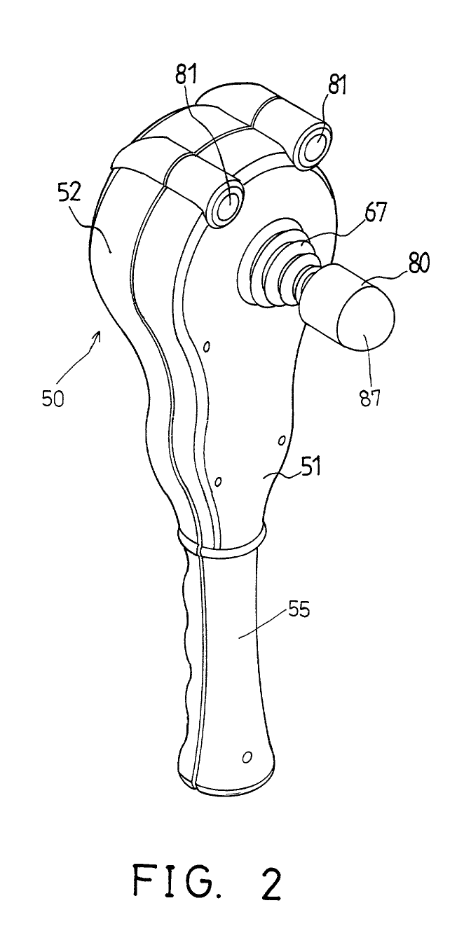

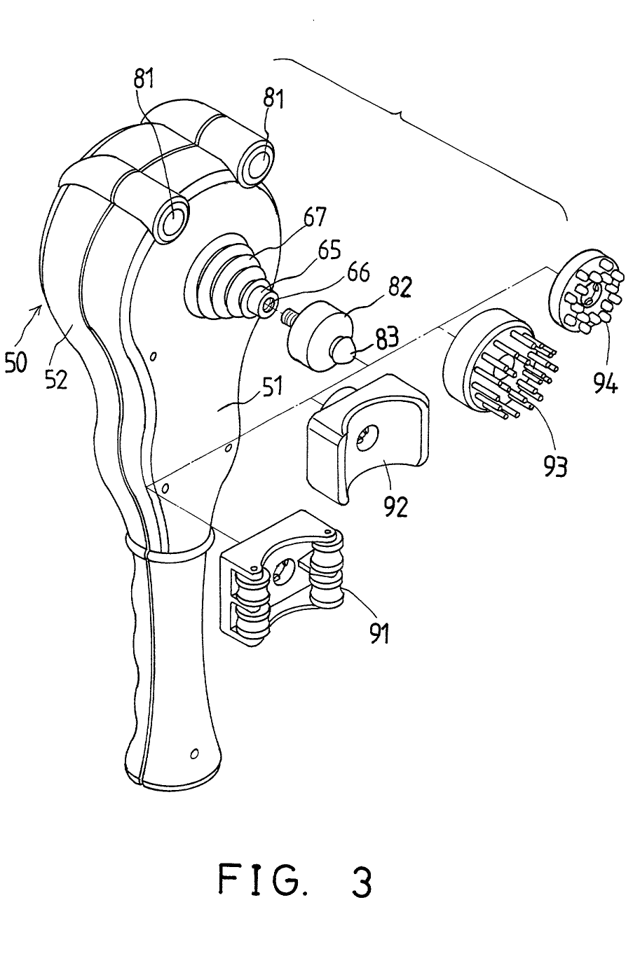

A shaft 63 is rotatably received in a follower 64 and includes an off-center bore 68 formed therein for receiving a spindle 69 of the motor 60. The follower 64 is also received in the chamber 54 of the housing 50. The shaft 63 is secured to the spindle 69 with such as the fasteners for allowing the shaft 63 to be rotated by the spindle 69 of the motor 60 and for allowing the motor 60 to vibrate or to move the follower 64 in a reciprocating action. The follower 64 includes a stem 65 extended therefrom and extended outward of the housing 50 through the orifice 53 of the casing 51 and having a screw hole 66 formed in the free end thereof for detachably and replaceably securing with various kinds of massage members 80, 82, 91, 92, 93, 94 (FIGS. 2, 3). A covering, such as a bellows type protective covering 67 is engaged onto the stem 65 and engaged with the housing 50 for shielding or covering the stem 65.

As shown in FIG. 2, the massage member 80 may be directly and detachably secured to the stem 65 by a threading engagement, and includes a rounded free end 87 for smoothly engaging with the users. As shown in FIG. 3, the massage member 82 may also be detachably secured to the stem 65 by a threading engagement, and includes a coupler 83 for detachably securing to the other massage members 91-94, such as the roller type massage member 91, the curved type massage member 92, the massage pins type massage member 93, and the massage projections type massage member 94.

The housing 50 may further include one or more infrared generating devices 81 attached thereto for generating infrared rays and for facilitating the blood circulation for the users. The massage members 80, 82, 91-94 may be changed with each other and may be driven by the eccentric engagement of the shaft 63 in the follower 64.

Accordingly, the massage device in accordance with the present invention includes an eccentric vibrating mechanism for vibrating the massage member of the massage device, and includes a number of massage members that may be changed with each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massage device comprising:
a housing,
a follower received in said housing and including a stem extended outward of said housing,
a massage member secured to said stem for engaging with and for massaging users, and
means for vibrating said follower to move said massage member to massage the users.

2. The massage device according to claim 1, wherein said vibrating means includes a shaft rotatably received in said follower and having an off-center bore formed therein, and means for rotating said shaft to vibrate said follower.

3. The massage device according to claim 2, wherein said rotating means includes a motor having a spindle engaged in said off-center bore of said shaft for rotating said shaft relative to said follower in an eccentric way.

4. The massage device according to claim 3 further comprising at least one pad engaged between said motor and said housing for absorbing a vibration generated by said motor.

5. The massage device according to claim 1 further comprising a protective covering engaged on said stem and engaged with said housing for shielding said stem.

6. The massage device according to claim 5, wherein said covering is a bellows type covering.

7. The massage device according to claim 1, wherein said housing includes a handle, and an electric facility received in said handle of said housing.

8. The massage device according to claim 1 further comprising at least one infrared generating device attached to said housing.

9. A massage device comprising:
a housing,
a follower received in said housing and including a stem extended outward of said housing, and
a first massage member and at least one second massage member detachably and changeably secured to said stem for selectively engaging with and for massaging users.

10. The massage device according to claim 9 further comprising means for vibrating said follower to move said massage members to massage the users.

11. The massage device according to claim 10, wherein said vibrating means includes a shaft rotatably received in said follower and having an off-center bore formed therein, and means for rotating said shaft to vibrate said follower.

12. The massage device according to claim 11, wherein said rotating means includes a motor having a spindle engaged in said bore of said shaft for rotating said shaft relative to said follower.
